(19) United States
(12) Patent Application Publication
(10) Pub. No.: US 2025/0390086 A1
(43) Pub. Date: Dec. 25, 2025

(54) SIMULATING INDUSTRIAL FACILITIES FOR CONTROL

(71) Applicant: DeepMind Technologies Limited, London (GB)

(72) Inventors: Praneet Dutta, Sunnyvale, CA (US); Iurii Chervonyi, Sunnyvale, CA (US); Octavian Voicu, San Francisco, CA (US); Jerry Jiayu Luo, San Mateo, CA (US); Piotr Trochim, St. Albans (GB)

(21) Appl. No.: 18/878,496

(22) PCT Filed: Jun. 23, 2023
(86) PCT No.: PCT/EP2023/067148

§ 371 Date: Dec. 23, 2024

Related U.S. Application Data
(60) Provisional application No. 63/354,930, filed on Jun. 23, 2022.

(51) Int. Cl. G05B 19/418

(52) U.S. Cl. CPC G05B 19/41885; G05B 2219/42163

(57) ABSTRACT

Methods, systems, and apparatus, including computer programs encoded on computer storage media, for simulating industrial facilities for control. One of the methods includes. at each of a plurality of time steps during a task episode: receiving, from a computer simulator of an industrial facility, measurements representing a current state of the facility; generating, from the measurements, an observation; providing the observation as input to a control policy for controlling the facility; receiving, as output, an action for controlling one or more setpoints of the facility; generating, from the action, one or more control inputs for the one or more setpoints of the facility; and providing, as input to the simulator, (i) the control inputs and (ii) current values for one or more configuration parameters of the simulator to cause the simulator to generate, as output, new measurements representing a new state of the facility.

### CROSS-REFERENCE TO RELATED APPLICATIONS

This application claims the benefit of priority to U.S. Provisional Application Ser. No. 63/354,930, filed Jun. 23, 2022, the entirety of which is incorporated herein by reference.

### BACKGROUND

This specification relates to controlling industrial facilities using machine learning models.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

### SUMMARY

This specification describes a system implemented as computer programs on one or more computers in one or more locations that simulates the operation of an industrial facility to allow a machine learning model to be trained to control the facility.

The subject matter described in this specification can be implemented in particular embodiments so as to realize one or more of the following advantages.

This specification describes techniques for training, evaluating, or both, a control policy for an industrial facility using a computer simulation of the industrial facility. Once the control policy has been trained and/or evaluated in simulation, the control policy can be deployed and used to control the (real-world) industrial facility.

More specifically, computer simulations of industrial facilities are deterministic-given an initial configuration, a state of the industrial facility, and a control input, the computer simulation will always update the state of the industrial facility in the same manner. This can make existing frameworks for training control policies in simulation poor choices for training a control policy for an industrial facility, because controlling industrial facilities requires control policies that are robust to any number of real-world imperfections that can result in a given control input impacting the state of the facility differently. For example, sensors of the facility can be noisy or can malfunction, the external conditions in the environment of the real-world facility can change rapidly, setpoints can malfunction, and so on. This specification describes a framework for training a control policy to be robust to such imperfections, for evaluating a control policy to determine whether the policy is robust to such imperfections, or both, without needing to modify the simulator or the RL agent that is performing the training. That is, this specification describes a framework that allows a deterministic simulator of an industrial facility to be effectively used to simulate real-world, non-determinism. In particular, by using an environment subsystem to interface between the RL agent and the simulator, the system can incorporate various aspects of non-determinism into the interaction, e.g., by introducing noise into control inputs, measurements, or both or by modifying configuration parameters of the simulator between task episodes and within a task episode. Moreover, the same framework can be employed to introduce these different degrees of non-determinism for multiple different simulators of different facilities and for multiple different tasks. In particular, the framework allows a very extended configurability-allowing a user to combine tasks, simulators, scenarios and noise, with each of these being independent axes of configurability.

In one example described herein, a method performed by one or more computers, comprises, at each of a plurality of time steps during a task episode: receiving, from a computer simulator of an industrial facility, measurements representing a current state of the industrial facility; generating, from the measurements, an observation; providing the observation as input to a control policy for controlling the industrial facility; receiving, as output from the control policy, an action for controlling one or more setpoints of the industrial facility; generating, from the action, one or more control inputs for the one or more setpoints of the industrial facility; and providing, as input to the computer simulator, (i) the one or more control inputs and (ii) current values for one or more configuration parameters of the computer simulator to cause the computer simulator to generate, as output, new measurements representing a new state of the industrial facility for a subsequent time step.

The configuration parameters may specify additional information (in addition to the control inputs) used by the computer simulator to represent the state of the industrial facility. Some example configuration parameters are described below.

Generating, from the measurements, an observation may comprise adding noise to the measurements. Generating, from the action, one or more control inputs for the one or more setpoints of the industrial facility may comprise adding noise to one or more control inputs defined by the observation. The method may further comprise identifying a scenario for the task episode. The scenario may specify, for each of the plurality of time steps, a respective modification to be applied to one or more of: one or more of the configuration parameters, one or more of the control inputs, or one or more of the measurements. The scenario may specify a modification to be applied to one or more of the configuration parameters.

The method may further comprise sampling a configuration for the task episode that specifies respective initial values for each of the configuration parameters. The method may include, at each time step: for each of the one or more configuration parameters, applying the modification specified by the scenario for the time step to the initial value for the configuration parameter to generate the current value for the configuration parameter. The scenario may specify a modification to be applied to one or more of the measurements. Generating, from the measurements, an observation may comprise for each of the one or more measurements, applying the modification specified by the scenario for the time step to the measurement. The scenario may specify a modification to be applied to one or more of the control inputs. Generating, from the action, one or more control inputs may comprise, for each of the one or more control inputs, applying the modification specified by the scenario for the time step to the control input.

The computer simulator may be a deterministic simulator of dynamics of the industrial facility. The method may further comprise training the control policy based at least on the task episode; and after the training, deploying the control policy for controlling the industrial facility. The method may further comprise evaluating the control policy based at least on the task episode; and after the evaluating, deploying the control policy for controlling the industrial facility.

The method may further comprise receiving, after deploying the control policy and from the industrial facility, measurements of a current state of the industrial facility; generating, from the measurements of the current state of the industrial facility, a second observation; providing the second observation as input to the control policy for controlling the industrial facility; receiving, as output from the control policy, a second action for controlling one or more setpoints of the industrial facility; generating, from the second action, second one or more control inputs for the one or more setpoints of the industrial facility; and controlling the one or more setpoints of the industrial facility based on the second one or more control inputs.

The method may further comprise controlling, using a second control policy, a second industrial facility in order to generate a data set; wherein the computer simulator of the industrial facility is configured to generate the measurements representing a current and new state of the industrial facility based upon the data set. The second industrial facility may be the same industrial facility as the industrial facility.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example simulation system.

FIG. 2 shows a more detailed view of the simulation system.

FIG. 3 shows an example of the operation of the simulation system during a task episode.

FIG. 4 is a flow diagram of an example process for performing a task episode using the simulator.

Like reference numbers and designations in the various drawings indicate like elements.

### DETAILED DESCRIPTION

This specification describes a system implemented as computer programs on one or more computers in one or more locations that simulates the operation of an industrial facility while the facility is being controlled by a control policy.

In particular, the control policy receives as input an observation that characterizes the state of the industrial facility and, in response, generates an action that specifies a respective setting for one or more setpoints of the industrial facility. Each setpoint is a different controllable element of the industrial facility. That is, the control policy controls the facility by repeatedly updating the settings for the one or more setpoints of the industrial facility.

For example, the control policy can be implemented as a neural network or other machine learning model and the system can be used to train the control policy in simulation before deploying the control policy for controlling the real-world industrial facility. For example, the control policy can be trained through reinforcement learning to maximize received rewards that represent the performance of the policy on some specified task.

As another example, the system can be controlled using one control policy, e.g., an already trained neural network or a fixed or heuristic-based control policy, in order to generate a data set. This data set can then be used to train another control policy, e.g., through offline reinforcement learning, without needing to use the other control policy to control the industrial facility. Alternatively or in addition, the data set can be used to evaluate the performance of another control policy, e.g., to determine whether the control policy is suitable for deployment for controlling the real-world industrial facility.

Generally, an industrial facility is one that includes one or more items of electronic equipment, mechanical equipment, or both that are controllable by the control policy. The control policy operates to control the industrial facility to perform a specified task.

In some implementations the facility is a service facility comprising a plurality of items of electronic equipment, such as a server farm or data center, for example a telecommunications data center, or a computer data center for storing or processing data, or any service facility. The service facility may also include ancillary control equipment that controls an operating environment of the items of equipment, for example environmental control equipment such as temperature control, e.g., cooling equipment, or air flow control or air conditioning equipment. This equipment can include, e.g., air-cooled chillers, water-cooled chillers, or both. The task may comprise a task to control, e.g., minimize, use of a resource, such as a task to control electrical power consumption, or water consumption while the facility is operating. Optionally, the optimization can be subject to one or more constraints.

In general the actions may be any actions that have an effect on the observed state of the environment, e.g., actions configured to adjust any of the sensed parameters described below. These may include actions to control, or to impose operating conditions on, the items of equipment or the ancillary control equipment, e.g., actions that result in changes to settings to adjust, control, or switch on or off the operation of an item of equipment or an item of ancillary control equipment. As a particular example, the actions can include actions to control one or more chillers operating within the facility.

In general observations of a state of the environment may comprise any electronic signals representing the functioning of the facility or of equipment in the facility. For example a representation of the state of the environment may be derived from observations made by any sensors sensing a state of a physical environment of the facility or observations made by any sensors sensing a state of one or more of items of equipment or one or more items of ancillary control equipment. These include sensors configured to sense electrical conditions such as current, voltage, power or energy; a temperature of the facility; fluid flow, temperature or pressure within the facility or within a cooling system of the facility; or a physical facility configuration such as whether or not a vent is open.

The rewards or return may relate to a metric of performance of the task. For example in the case of a task to control, e.g., minimize, use of a resource, such as a task to control use of electrical power or water, the metric may comprise any metric of use of the resource.

In some implementations the facility is a power generation facility, e.g., a renewable power generation facility such as a solar farm or wind farm. The task may comprise a control task to control power generated by the facility, e.g., to control the delivery of electrical power to a power distribution grid, e.g., to meet demand or to reduce the risk of a mismatch between elements of the grid, or to maximize power generated by the facility. The actions may comprise actions to control an electrical or mechanical configuration of an electrical power generator such as the electrical or mechanical configuration of one or more renewable power generating elements, e.g., to control a configuration of a wind turbine or of a solar panel or panels or mirror, or the electrical or mechanical configuration of a rotating electrical power generation machine. Mechanical control actions may, for example, comprise actions that control the conversion of an energy input to an electrical energy output, e.g., an efficiency of the conversion or a degree of coupling of the energy input to the electrical energy output. Electrical control actions may, for example, comprise actions that control one or more of a voltage, current, frequency or phase of electrical power generated.

The rewards or return may relate to a metric of performance of the task. For example in the case of a task to control the delivery of electrical power to the power distribution grid the metric may relate to a measure of power transferred, or to a measure of an electrical mismatch between the power generation facility and the grid such as a voltage, current, frequency or phase mismatch, or to a measure of electrical power or energy loss in the power generation facility. In the case of a task to maximize the delivery of electrical power to the power distribution grid the metric may relate to a measure of electrical power or energy transferred to the grid, or to a measure of electrical power or energy loss in the power generation facility.

In general observations of a state of the environment may comprise any electronic signals representing the electrical or mechanical functioning of power generation equipment in the power generation facility. For example a representation of the state of the environment may be derived from observations made by any sensors sensing a physical or electrical state of equipment in the power generation facility that is generating electrical power, or the physical environment of such equipment, or a condition of ancillary equipment supporting power generation equipment. Such sensors may include sensors configured to sense electrical conditions of the equipment such as current, voltage, power or energy; temperature or cooling of the physical environment; fluid flow; or a physical configuration of the equipment; and observations of an electrical condition of the grid, e.g., from local or remote sensors. Observations of a state of the environment may also comprise one or more predictions regarding future conditions of operation of the power generation equipment such as predictions of future wind levels or solar irradiance or predictions of a future electrical condition of the grid.

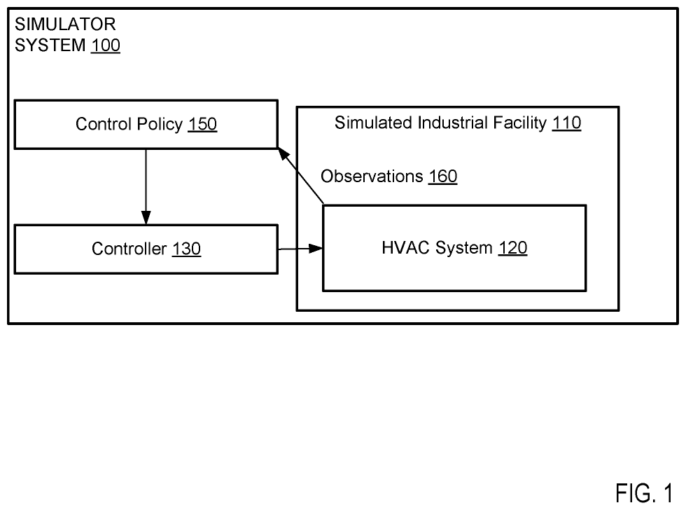

FIG. 1 is a diagram of an example simulation system 100. The simulation system 100 is an example of a system implemented as computer programs on one or more computers in one or more locations, in which the systems, components, and techniques described below can be implemented.

The system 100 will be described as being used to control the heating, ventilating, and air conditioning (HVAC) system 120 of a simulated industrial facility 110.

More generally, however, the system 100 can be used to control any aspect of the operation of any type of industrial facility 110, e.g., one of the aspects described above.

The simulated industrial facility 110 (also referred to as a simulator 110) is a computer simulation of a real-world industrial facility, i.e., that models states and dynamics of the real-world industrial facility that would be observed in various contexts using one or more computer programs. That is, the simulator 110 is one or more software programs that maintains a state of the real-world industrial facility, e.g., current readings of sensors within the facility and optionally additional information, and receives as input (i) current values of configuration parameters specifying a configuration of the simulator and (ii) control inputs for one or more setpoints of the industrial facility and provides as output measurements, i.e., updated readings of the sensors within the facility, that reflect an updated state of the facility as a result of the control inputs.

The system 100 can make use of any appropriate computer simulator. For example, a user of the system can provide the system 100 with access to a computer simulator of a real-world facility that is of interest to the user, e.g., by allowing the system 100 to access the simulator through an API or other interface or by allowing the system 100 to execute the simulator.

Generally, the problem of controlling an industrial facility to perform a specified task can be framed as a multi-objective optimization subject to constraints.

In the HVAC example, a controller 130 controls a number of setpoints that regulate the temperature exchange characteristics of the HVAC system 110 to perform a task, e.g., trying to keep the facility temperature at a certain level. In the HVAC example, the setpoints can include enabling and disabling selected chillers and, optionally, configuring chiller leaving temperatures.

The HVAC components draw power from the grid, so the next goal of the controller 130 can be to reduce power consumption. Thus, the overall task performed by the controller 130 can be framed as minimizing power consumption by the HVAC system 110 while satisfying one or more constraints on the facility temperature.

If the controller fails at its task, it risks overheating the facility, which can lead to dire consequences, e.g., failure of computer components resulting in data loss or downtime of electrical or mechanical components that are essential to the operation of the facility. To prevent this from happening, manufacturers of controllers 130 introduce a set of failsafe constraints that prevent such an event from taking place. Violating a constraint not only undermines the reliability of a controller, but also usually results in the controller being disconnected from the facility and no longer being able to optimize for the power consumption.

The system 100 can be used to provide a set of simulated scenarios that can be used to train and evaluate controllers (e.g., control policies implemented as machine learning models) safely and efficiently. That is, the system 100 can be used to train, evaluate, or both, a control policy that controls one of or more of the setpoints that are specified by the controller 130 for the simulator 110.

More specifically, during the operation of the system 100, a control policy 150 (e.g., a reinforcement learning agent) performs a task in a closed-loop control system using the simulator 110 as the ground-truth model of the facility dynamics.

The system 100 uses the simulator 110 to evaluate the effect of actions proposed by the policy 150 on the current state of the simulation.

The simulator 110 returns the results in the form of measurements, which are a subset of the simulation state. The measurements can include current readings from any of a variety of sensors of the industrial facility.

The system 100 processes the measurements into observations 160 that are provided as input to the control policy 150.

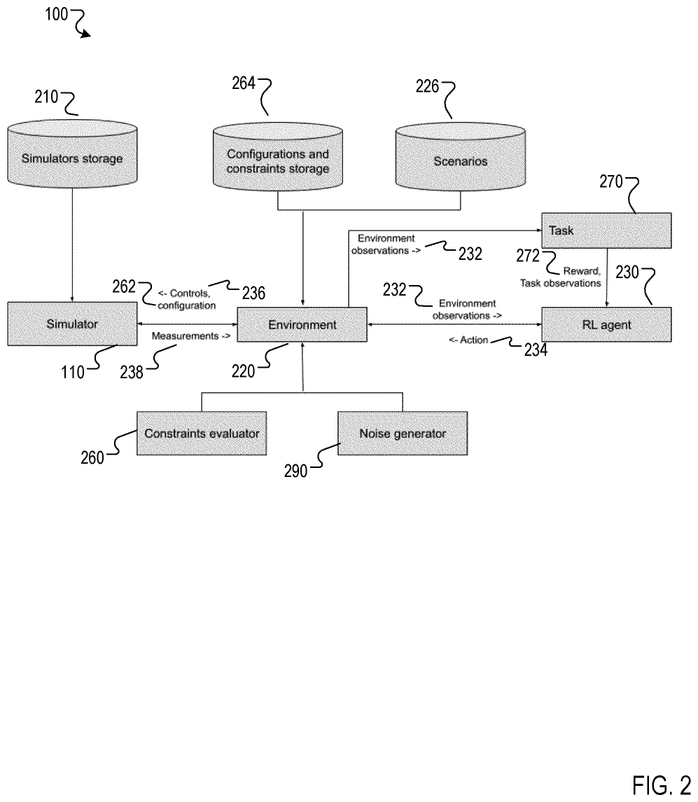

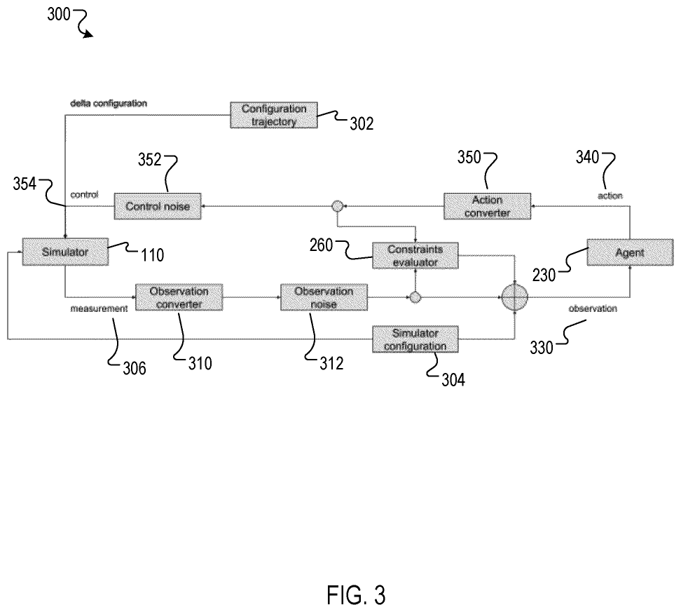

However, HVAC simulation is deterministic, i.e., performing a given action in a given simulated state will always result in the same updated state. Control of real-world HVAC systems, however, requires accounting for any of a variety of non-deterministic elements that may be encountered during operation and that can modify how actions impact the state of the facility. Examples of these non-deterministic elements (also referred to as “imperfections”) will be described in more detail below with reference to FIGS. 2 and 3.

In order to introduce imperfections, the system 100 can introduce noise into various aspects of the control pipeline, e.g., one or more of the control input, simulation configuration and observations. This will be described in more detail below with reference to FIGS. 2 and 3.

FIG. 2 shows a more detailed view of the simulation system 100.

As shown in FIG. 2, the simulation system 100 includes the simulator 110. In some implementations, the system 100 can also include a simulator data storage 210 that stores specifications for multiple different simulators, e.g., so that an appropriate simulator can be selected for a given task for controlling a given real-world facility.

During operation, the simulation system 100 represents interaction with the simulator 110 as interactions with an environment subsystem 220.

The environment subsystem 220 is implemented as one or more computer programs and controls interaction with the simulator 110 by an RL agent 230. The RL agent 230 can include a control policy and associated components for training the control policy through reinforcement learning based on the interactions of the control policy with the simulator 110.

As can be seen from FIG. 2, the RL agent 230 receives as input observations and provides as output actions 234 for controlling one or more setpoints of the facility being simulated. The input observations include environment observations 232 and, optionally, “task observations” 272 that include additional information that is specific to the task being performed (e.g., that are generated from the environment observation 232 in accordance with some task parameters).

The environment subsystem 220 translates the actions 234 into control inputs 236 and provides the control inputs 236 to the simulator 110. For example, translating the actions 234 can include converting a high-level action (e.g., an indicator that a chiller should be disabled) into instructions or other commands that can be executed within the facility to carry out the high-level action (e.g., a machine-readable instruction to disable the chiller).

The environment subsystem 220 also provides values for configuration parameters 262 as input to the simulator 110.

The configuration parameters 262 specify additional information (in addition to the control inputs 236) required by the simulator 110 to fully represent the state of the real-world industrial facility. That is, the configuration parameters are the parameters necessary to initialize the simulator, i.e., to fully represent the state of the real-world facility.

As one example, the configuration parameters 262 can specify values for setpoints that are not controlled by the RL agent 250 but that are required to be specified by the controller. For example, when the setpoints include enabling and disabling selected chillers and configuring chiller leaving temperatures but the RL agent 230 only controls enabling and disabling the chillers, the configuration parameters specify the chiller leaving temperatures for the chillers.

The configuration parameters 262 also specify properties of the external environment of the real-world industrial facility. For example, the configuration parameters 262 can specify the temperature of the external environment, the humidity of the external environment, the precipitation rate of the external environment, and so on.

For example, prior to beginning a task episode, the environment subsystem 220 can sample a configuration that specifies respective initial values for each of the configuration parameters, e.g., that model a real-world configuration of the real industrial facility, from a configuration storage 264. In some cases, as will be described below, the subsystem 220 can modify the initial values during the course of the task episode while in other cases the subsystem 220 can maintain the initial values throughout the task episode.

The simulator 110 returns measurements 238 that reflect an updated state of the simulator 110 as a result of the control inputs 236 being applied when in the configuration specified by the configuration parameters 238.

The environment subsystem 220 then translates the measurements 238 into observations 232 that are provided as input to the RL agent 230. For example, a user can provide to the system a specification of the input received by the RL agent 230, i.e., which sensor measurements are provided as input, the expected range for the sensor measurements, the numerical format for the sensor measurements, and so on. The subsystem 220 can then standardize the measurements 238 so that they fit the specification for the observations 232 that was provided by the user.

As described above, the RL agent 230 controls the simulator 110 in order to perform a specified task, e.g., optimize one or more metrics of performance subject to one or more constraints. The constraints can include constraints on the measurements, e.g., temperature not exceeding a threshold, constraints on the actions, e.g., a given chiller not enabled for more than a consecutive window of time, or both.

To determine whether any of the constraints are violated by a given action or measurement, the system 100 includes a constraints evaluator 260 that maintains data specifying the current set of constraints for the task being performed by the RL agent 230. In particular, each configuration in the storage 264 is associated with a set of constraints for a given task.

The evaluator 260 receives an input that includes the current action, the current set of measurements, or both, and determines whether any of the current set of constraints as specified by the configuration for the current task episode are violated. The evaluator 260 then provides data identifying whether any constraint violations have occurred to the environment subsystem 220, which can provide this information to the RL agent 230 as part of the corresponding observations.

The constraints for a given task can include soft constraints, hard constraints or both.

A soft constraint is one that can be violated and only results in a negative impact to the evaluation of the performance of the RL agent 230.

A hard constraint is one that cannot be violated, i.e., violation of the constraint results in the controller being disconnected from the facility. When the evaluator 260 determines that a hard constraint has been violated, the environment subsystem 220 can terminate the current episode of control, i.e., provide an indication to the RL agent 230 that a hard constraint has been violated and that the RL agent 230 can no longer continue this instance of the simulation.

In order to train the RL agent 230 or evaluate the performance of an already-trained RL agent 230, the RL agent requires a training signal. In reinforcement learning, this is represented in the form of a set of rewards 272, which are numerical values that are generated by a task subsystem 270 based on any appropriate information, e.g., the results of the constraints evaluation, the measurements, and the control inputs. The mapping from this information to one or more numerical values that represent the rewards 272 can be specified by a user of the system 100.

The RL agent 230 can use the rewards 272, the environment observations 232, and the actions 234 to train the control policy using any appropriate reinforcement learning technique, e.g., an on-policy or off-policy reinforcement learning algorithm.

Alternatively, as described above, the RL agent 230 can store the rewards 272, the environment observations 232, and the actions 234 for use in training another policy through off-line reinforcement learning, or for evaluating another policy as described above.

Once a given policy has been trained, the given policy can be used to control the real-world facility that is simulated by the simulator 110.

Instead of directly providing the actions 234 as the control inputs 236 and directly providing the measurements 238 as observations 232, which would result in a deterministic control loop, the environment subsystem 220 uses any of a variety of components to introduce imperfections into the control process.

In particular, the environment subsystem 220 can make use of one or more of: scenarios 226 or a noise generator 290.

As a particular example, the environment subsystem 220 can use noise generated by the noise generator 290 to add noise to the control inputs as part of translating actions into control inputs, to the observation as part of translating measurements into observations, or both. The noise is added to simulate sensor/pipeline imperfections, and in effect diversifies the distribution of simulated states (control noise) and observations (observation noise). The parameters for the noise generator 290, e.g., the parameters of the noise distribution from which the noise is sampled or when and where the noise is applied or both can be specified by a user or sampled by the system 100 from a set of possible parameters.

A scenario 226 models a real-world scenario of interest and the scenario 226 to be used for a given task episode can be specified by the user or sampled by the system 100 from a set of scenarios. Examples of scenarios 226 are those that are used to model environmental instabilities during the operation of the real-world facility that are not effectively captured by the operation of the simulator 110. One example of such a real-world scenario is to simulate the changing weather conditions in the environment of the facility, which can have an impact on the effect of actions on the state of the facility.

More specifically, a scenario 226 is implemented as a modification to the inputs to the simulator, i.e., the configuration parameters 262 that are being used for a given task and/or the control inputs provided to the simulator, a modification to the outputs of the simulator 110, i.e., a modification to the measurements generated by the simulator 110, or both.

As described above, configuration parameters 262 include information about the state of the facility. When a scenario 226 is selected that modifies the configuration parameters, the environment subsystem 220 uses the scenario 226 to modify the configuration parameters 262 before providing the configuration parameters 262 as input to the simulator 110. When a scenario 226 is selected that modifies the control inputs, the environment subsystem 220 uses the scenario 226 to modify the control inputs before providing the control inputs as input to the simulator 110. When a scenario 226 is selected that modifies the measurements, the environment subsystem 220 uses the scenario 226 to modify the measurements before translating the measurements into an observation.

Thus, at each episode step, in addition to sending the control inputs, the environment subsystem 220 also changes the values of one or more of: the selected configuration parameters 262 according to the scenario 226, the selected control inputs themselves, or the selected measurements that are provided in response to the control inputs.

In particular, a scenario 226 can be implemented as a time dependent function that produces values used as modifiers to one or more of: (i) one or more configuration parameters, (ii) one or more control inputs, or (iii) one or more measurements. That is, the scenario 226 maps a time index during an episode of control to a respective modifier for one or more of (i), (ii), or (iii).

Some specific examples of scenarios 226 follow.

One example of a scenario 226 is a baseline scenario that does not make use of the configuration trajectories. The baseline scenario can be used to test an agent's performance while controlling an unperturbed simulated facility and develop a fitness baseline for comparison with other tasks. Thus, in this scenario, the initial parameter values specified by the configuration are used throughout the episode.

Another example of a scenario 226 is a sensor drift scenario. This scenario introduces a temporally correlated noise into a set of selected measurement components. For example, the components can be selected at random at the beginning of each episode. This scenario can test an agent's resilience to partially false information.

Another example of a scenario 226 is a frozen controls scenario. The scenario freezes the values of selected controls for a random amount of time. That is, rather than applying the value for the control that is specified by the action, the environment subsystem 220 instead samples a random time interval length, and during that time interval length provides, to the environment, the value of the selected control that was selected immediately before the time interval began. For example, the controls can be selected at random at the beginning of each episode. This scenario can test an agent's ability to detect when a selected policy fails and adapt by switching to an alternative.

Another example of a scenario 226 is a non-stationarity dynamics scenario. The scenario uses a set of configuration trajectories to modify selected simulation configuration parameters that represent aspects of the real-world environment of the real-world facility over the course of an episode. Configuration trajectories produce changes to selected parameters, which the subsystem 220 adds to their baseline values and subsequently passes to the simulator 110. Examples of such parameters include external environment temperature, humidity, wind speed, precipitation, and so on. This scenario can test an agent's resilience to ever changing environmental conditions, building load and other variables outside the domain of agent's control.

Another example of a scenario is a degradation of equipment scenario. The scenario uses a set of configuration trajectories to modify selected simulation configuration parameters that represent the efficiency or other measure of performance of equipment in the facility, e.g., pumps, heat exchangers, cooling tower, chillers, and so on. This scenario can test an agent's resilience to degradation of equipment performance, e.g., as a result of wear and tear, during the operation of the facility.

Thus, a given task episode is specified by the choice of a simulator 110 from the simulator storage 210, a simulator configuration that specifies initial configuration parameter values 262, a scenario 226, and, optionally, noise parameters for the noise generator 290. Once these are specified, e.g., sampled by the system or specified by a user, the system 100 can execute a task episode in order to generate training data for the RL agent 230.

FIG. 3 shows an example 300 of the operation of the simulation system 100 during a task episode.

A task “episode” is a sequence of time steps at which the agent 230 controls the simulator 110. A “time step” is a time interval during which measurements are received from the simulator 110 and control inputs are provided to the simulator in response to the measurements. A task episode can terminate, e.g., if a predetermined number of time steps have occurred, if a hard constraint has been violated, or if an error occurs in the simulator 110.

Prior to initiating a task episode, the system selects a configuration 304. For example, the system can select a predetermined or randomly sampled initial configuration for the configuration parameters of the simulator 110.

The system also identifies a scenario, which is represented as a configuration trajectory 302 that assigns a respective value or a respective modification to one or more of: one or more of the configuration parameters, one or more of the control inputs, or one or more of the measurements, at each time step during the episode. That is, the scenario defines a time-dependent function for updating the initial configuration 304, the measurements, and/or the control inputs.

At each time step, the agent 230 receives an observation 330 and selects an action 340 that specifies values for one or more setpoints of the simulator 110.

An action converter 350 converts the action 340 into control inputs 354 for the simulator 110. As part of the conversion, the action converter 350 can add noise 352 to the control inputs.

The simulator receives the control inputs 354 and values of the configuration parameters generated by applying the trajectory 302 to the configuration 304 and generates measurements 306 that include respective current values for each of a set of sensors of the facility as result of the control input 354 being applied given the configuration parameter values.

An observation converter 310 (e.g., part of the environment subsystem 220) converts the measurements 306 into the next observation 330 for the agent 230. In particular, as part of converting the observation, the converter 310 can add observation noise 312 to one or more of the measurements 306. If the scenario requires that one of the sensors has sensor drift, the observation noise 312 can reflect the specified noisy reading of the selected sensor.

The constraints evaluator 260 then evaluates the control inputs generated from the action proposed by the agent 230 and the observation generated from the measurements 306 to determine whether any of the constraints are violated. Information specifying which, if any, constraints are violated can then be added to the next observation 330 before the observation 330 is passed to the agent 230.

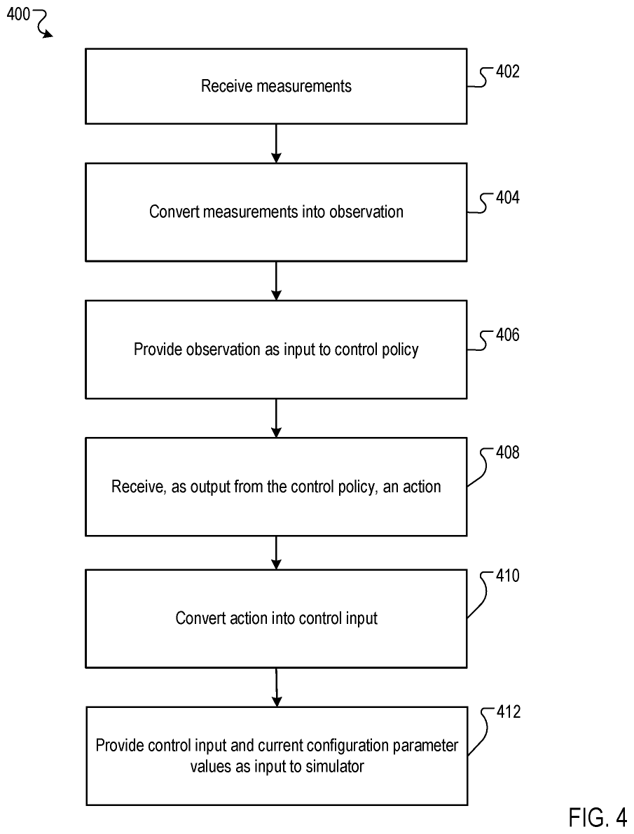

FIG. 4 is a flow diagram of an example process 400 for performing a task episode using the simulator. For convenience, the process 400 will be described as being performed by a system of one or more computers located in one or more locations. For example, a simulation system, e.g., the simulation system 100 depicted in FIG. 1, appropriately programmed in accordance with this specification, can perform the process 400.

Prior to the task episode, the system can select a simulator configuration and a scenario. For example, the system can randomly sample the configuration from a set of possible configurations that model real-world operational conditions of the facility and can receive the scenario as a user input. As another example, the system can randomly sample both the configuration and the scenario.

The system then performs the following steps at each time step during the task episode.

The system receives, as output from a simulator, measurements representing a current state of an industrial facility being modeled by the simulator (step 402).

The system converts the measurements into an observation (step 404).

The system provides the observation as input to a control policy (step 406). For example, the control policy may be a policy that is being trained by an RL agent.

The system receives, as output from the control policy, an action (step 408).

The system converts the action into a control input for the simulator (step 410).

The system provides the control input and current values for configuration parameters as input to the simulator (412), i.e., for use in generating new measurements representing the next state of the industrial facility.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A method performed by one or more computers, the method comprising:
at each of a plurality of time steps during a task episode:
receiving, from a computer simulator of an industrial facility, measurements representing a current state of the industrial facility;
generating, from the measurements, an observation;
providing the observation as input to a control policy for controlling the industrial facility;
receiving, as output from the control policy, an action for controlling one or more setpoints of the industrial facility;
generating, from the action, one or more control inputs for the one or more setpoints of the industrial facility; and
providing, as input to the computer simulator, (i) the one or more control inputs and (ii) current values for one or more configuration parameters of the computer simulator to cause the computer simulator to generate, as output, new measurements representing a new state of the industrial facility for a subsequent time step.

2. The method of claim 1, wherein generating, from the measurements, an observation comprises:
adding noise to the measurements.

3. The method of claim 1, wherein generating, from the action, one or more control inputs for the one or more setpoints of the industrial facility comprises:
adding noise to one or more control inputs defined by the observation.

4. The method of claim 1, further comprising:
identifying a scenario for the task episode, wherein the scenario specifies, for each of the plurality of time steps, a respective modification to be applied to one or more of:
one or more of the configuration parameters,
one or more of the control inputs, or
one or more of the measurements.

5. The method of claim 4, wherein the scenario specifies a modification to be applied to one or more of the configuration parameters, wherein the method further comprises:
sampling a configuration for the task episode that specifies respective initial values for each of the configuration parameters, and at each time step:
for each of the one or more configuration parameters, applying the modification specified by the scenario for the time step to the initial value for the configuration parameter to generate the current value for the configuration parameter.

6. The method of claim 4, wherein the scenario specifies a modification to be applied to one or more of the measurements, and wherein generating, from the measurements, an observation comprises:
for each of the one or more measurements, applying the modification specified by the scenario for the time step to the measurement.

7. The method of claim 4, wherein the scenario specifies a modification to be applied to one or more of the control inputs, and wherein generating, from the action, one or more control inputs comprises:
for each of the one or more control inputs, applying the modification specified by the scenario for the time step to the control input.

8. The method of claim 1, wherein the computer simulator is a deterministic simulator of dynamics of the industrial facility.

9. The method of claim 1, further comprising:
training the control policy based at least on the task episode; and
after the training, deploying the control policy for controlling the industrial facility.

10. The method of claim 1, further comprising:
evaluating the control policy based at least on the task episode; and
after the evaluating, deploying the control policy for controlling the industrial facility.

11. The method of claim 9, further comprising:
receiving, after deploying the control policy and from the industrial facility, measurements of a current state of the industrial facility;
generating, from the measurements of the current state of the industrial facility, a second observation;
providing the second observation as input to the control policy for controlling the industrial facility;
receiving, as output from the control policy, a second action for controlling one or more setpoints of the industrial facility;
generating, from the second action, second one or more control inputs for the one or more setpoints of the industrial facility; and
controlling the one or more setpoints of the industrial facility based on the second one or more control inputs.

12. The method of claim 1, further comprising:
controlling, using a second control policy, a second industrial facility in order to generate a data set;
wherein the computer simulator of the industrial facility is configured to generate the measurements representing a current and new state of the industrial facility based upon the data set.

13. (canceled)

14. One or more non-transitory computer-readable storage media storing instructions that when executed by one or more computers cause the one or more computers to perform operations comprising:
at each of a plurality of time steps during a task episode:
receiving, from a computer simulator of an industrial facility, measurements representing a current state of the industrial facility;
generating, from the measurements, an observation;
providing the observation as input to a control policy for controlling the industrial facility;
receiving, as output from the control policy, an action for controlling one or more setpoints of the industrial facility;
generating, from the action, one or more control inputs for the one or more setpoints of the industrial facility; and
providing, as input to the computer simulator, (i) the one or more control inputs and (ii) current values for one or more configuration parameters of the computer simulator to cause the computer simulator to generate, as output, new measurements representing a new state of the industrial facility for a subsequent time step.

15. A system comprising one or more computers and one or more storage devices storing instructions that when executed by one or more computers cause the one or more computers to perform operations comprising:
at each of a plurality of time steps during a task episode:
receiving, from a computer simulator of an industrial facility, measurements representing a current state of the industrial facility;
generating, from the measurements, an observation;
providing the observation as input to a control policy for controlling the industrial facility;
receiving, as output from the control policy, an action for controlling one or more setpoints of the industrial facility;
generating, from the action, one or more control inputs for the one or more setpoints of the industrial facility; and
providing, as input to the computer simulator, (i) the one or more control inputs and (ii) current values for one or more configuration parameters of the computer simulator to cause the computer simulator to generate, as output, new measurements representing a new state of the industrial facility for a subsequent time step.

16. The system of claim 15, wherein generating, from the measurements, an observation comprises:
adding noise to the measurements.

17. The system of claim 15, wherein generating, from the action, one or more control inputs for the one or more setpoints of the industrial facility comprises:
adding noise to one or more control inputs defined by the observation.

18. The system of claim 15, the operations further comprising:
identifying a scenario for the task episode, wherein the scenario specifies, for each of the plurality of time steps, a respective modification to be applied to one or more of:
one or more of the configuration parameters,
one or more of the control inputs, or
one or more of the measurements.

19. The system of claim 18, wherein the scenario specifies a modification to be applied to one or more of the configuration parameters, wherein the method further comprises:
sampling a configuration for the task episode that specifies respective initial values for each of the configuration parameters, and at each time step:
for each of the one or more configuration parameters, applying the modification specified by the scenario for the time step to the initial value for the configuration parameter to generate the current value for the configuration parameter.

20. The system of claim 18, wherein the scenario specifies a modification to be applied to one or more of the measurements, and wherein generating, from the measurements, an observation comprises:
for each of the one or more measurements, applying the modification specified by the scenario for the time step to the measurement.

21. The system of claim 18, wherein the scenario specifies a modification to be applied to one or more of the control inputs, and wherein generating, from the action, one or more control inputs comprises:
for each of the one or more control inputs, applying the modification specified by the scenario for the time step to the control input.
